(19) United States
(12) Patent Application Publication
(10) Pub. No.: US 2011/0239207 A1
(43) Pub. Date: Sep. 29, 2011

(54) SYSTEM, METHOD AND PROGRAM PRODUCT FOR IDENTIFYING DIFFERENCES BETWEEN SETS OF PROGRAM CONTAINER FILES

(75) Inventor: Taylor B. Wayman, Longmont, CO (US)

(73) Assignee: INTERNATIONAL BUSINESS MACHINES CORPORATION, Armonk, NY (US)

(21) Appl. No.: 13/156,912

(22) Filed: Jun. 9, 2011

Related U.S. Application Data
(63) Continuation of application No. 10/818,760, filed on Apr. 6, 2004, now abandoned.

(51) Int. Cl. G06F 9/44

(52) U.S. Cl. 717/168

(57) ABSTRACT

A system and program for comparing a preexisting, hierarchical set of program container files to an updated, hierarchical set of program container files to identify one or more of the program container files or files within the program container files that have been deleted, added or changed in the updated program container file. First program instructions expand a first higher-level program container file within the preexisting set of program container files into first lower-level program container file(s) and other file(s). The first program instructions also expand a corresponding second higher-level program container file within the updated set of program container files into second lower-level program container file(s) and other file(s). Second program instructions identify one or more of the first lower-level program container file(s) and other file(s) that do not exist in the second lower-level program container file(s) and other file(s), and identify one or more of the second lower-level program container file(s) and other file(s) that do not appear in the first lower-level program container file(s) and other file(s). Third program instructions identify one or more of the second lower-level program container file(s) and other file(s) which have been changed relative to corresponding one or more of the first lower-level program container file(s) and other file(s). The foregoing process is repeated for the changed program container files.

### BACKGROUND

The invention relates generally to computer systems, and deals more particularly with a technique to identify differences between preexisting and updated hierarchical sets of program container files and the files within the program container files.

Hierarchical sets of program container files are known today, such as IBM Enterprise Archive (“EAR”) files and Java Archive (“JAR”) files. Each program container file may contain program code files, one or more directory files, object files, program parameters files, other lower level program container files, etc. A “directory” file is a hierarchical listing of program files. Each of the lower level program container files may contain program code files, one or more directory files, object files, program parameters files, other lower level program container files, etc. Because a program container file may contain other lower level program container files, a program container file can be considered a level in a hierarchy of program container files.

In the prior art, a customer had a “preexisting”, hierarchical set of program container files, and then received from a software vendor an updated version of the set of program container files. The updated set of program container files contained updates to one or more files within one or more levels of the preexisting set of program container files. The vendor described in text the general nature of the changes in program function provided by the updated set of program container files. The vendor also supplied a list of which files within the updated set of program container files were updated (i.e. added, deleted or changed in content). Then, the customer verified that the vendor changed the files the vendor said it changed, as follows. By appropriate, manually-entered command to the operating system, the customer opened each program container file that the vendor listed as updated to reveal the files within the program container file. Then, for each file which the vendor listed as changed in content, the operator sent a “sum” command to the operating system to compare the updated version to the preexisting version of the file to determine if any changes were made. The “sum” command is a known Unix, IBM AIX or Sun Solaris operating system command which causes the operating system to apply a function against the contents of the file and yield a (probably) unique value representative of the contents. (In general, the sum function treats the file as an enormous binary number and divides the file binary number by a fixed binary number; the remainder is the “sum” or “checksum”. The checksum may also comprise a thirty two bit cyclic redundancy check and byte count for the file.) If two files yield the same “sum” value, then their contents are probably the same; otherwise the contents are probably different. If any changes were made as indicated by differences in the “sum” value, then the customer assumed that the vendor made the changes that the vendor stated. For each file which the vendor said it deleted, the operator checked the listing of files within the preexisting version to make sure it was there, and then checked the listing of files within the updated version to make sure it was not there. For each file which the vendor said it added, the operator checked the listing of files within the preexisting version to make sure it was not there, and then checked the listing of files within the updated version to make sure it was there. However, it is possible that the vendor made other updates (additions, deletions or content changes) to the preexisting set of program container files that were not listed by the vendor or revealed by the foregoing process.

Accordingly, an object of the present invention is to automatically detect such other changes to the preexisting set of program container files.

### SUMMARY OF THE INVENTION

The invention resides in a system, computer program product and method for comparing a preexisting, hierarchical set of program container files to an updated, hierarchical set of program container files to identify one or more of the program container files or files within the program container files that have been deleted, added or changed in the updated program container file. First program instructions expand a first higher-level program container file within the preexisting set of program container files into first lower-level program container file(s) and other file(s). The first program instructions also expand a corresponding second higher-level program container file within the updated set of program container files into second lower-level program container file(s) and other file(s). Second program instructions identify one or more of the first lower-level program container file(s) and other file(s) that do not exist in the second lower-level program container file(s) and other file(s), and identify one or more of the second lower-level program container file(s) and other file(s) that do not appear in the first lower-level program container file(s) and other file(s). Third program instructions identify one or more of the second lower-level program container file(s) and other file(s) which have been changed relative to corresponding one or more of the first lower-level program container file(s) and other file(s). Fourth program instructions automatically iterate the first and second program instructions for (a) each of the one or more second lower-level program container file(s) which have been changed and (b) each of the corresponding one or more of said first lower-level program container file(s). Consequently, the first and second program instructions operate upon each of the one or more second lower-level program container file(s) which have been changed as the first and second program instructions operated upon the second higher-level program container file. Also, the first and second program instructions operate upon each of the corresponding one or more of the first lower-level program container file(s) as the first and second program instructions operated upon the first higher-level program container file.

According to one feature of the present invention, fifth program instructions receive identification from an external source of one or more of the second lower-level other files that have been changed in the updated set of program container files relative to the preexisting set of program container files. The third program instructions identify one of more of the second lower-level other files which have been changed that were not identified from the external source.

### BRIEF DESCRIPTION OF THE FIGURES

FIG. 1 is a block diagram of a computer system in which the file update checking program according to the present invention is incorporated.

FIG. 2(a) is a diagram of a preexisting set of program container files, and FIG. 2(b) is a diagram of an updated version of this preexisting set of program container files.

FIG. 3 is a flow chart illustrating the file update checking program of FIG. 1.

### DETAILED DESCRIPTION OF THE PREFERRED EMBODIMENTS

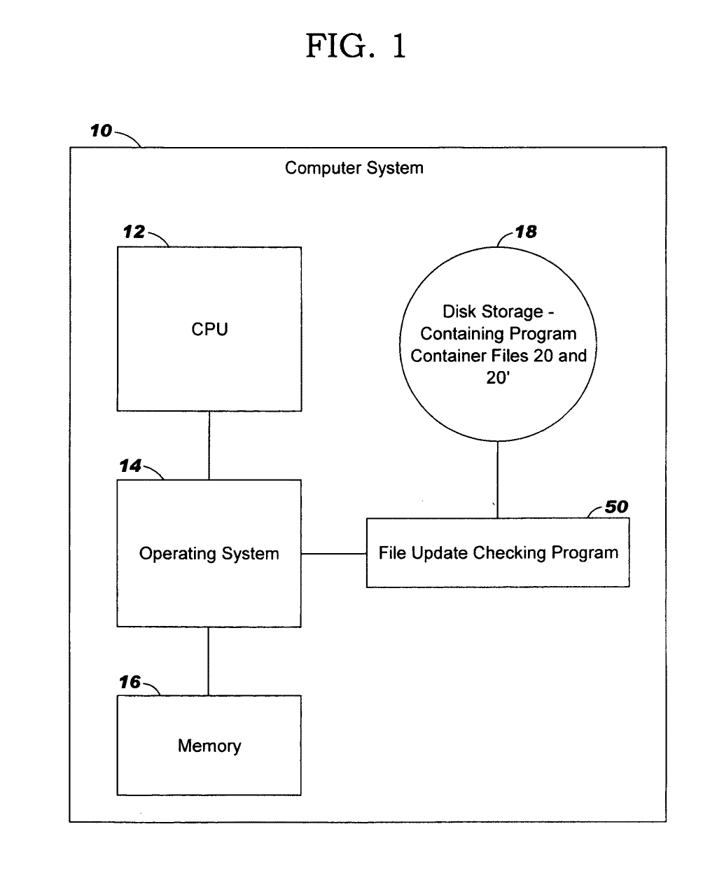

The present invention will now be described in detail with reference to the figures. FIG. 1 illustrates a computer system generally designated 10 which incorporates the present invention. System 10 comprises a processor 12, operating system 14, memory 16 and disk storage 18. Disk storage 18 contains multiple set of program container files 20, 30 and 40 of preexisting set of program container files. By way of example, each of the set of program container files 20, 30 and 40 can be an EAR file or JAR file. Disk storage 18 also contains an updated set of program container files 20′, corresponding to the preexisting set of program container files 20. FIG. 1 also illustrates file update checking program 50 which automatically checks if any additions, deletions or changes were made to any files within the preexisting set of program container files to form the files in the updated set of program container files. (Program 50 was loaded into system 10 from a floppy disk, CD ROM, a network or other computer readable medium.)

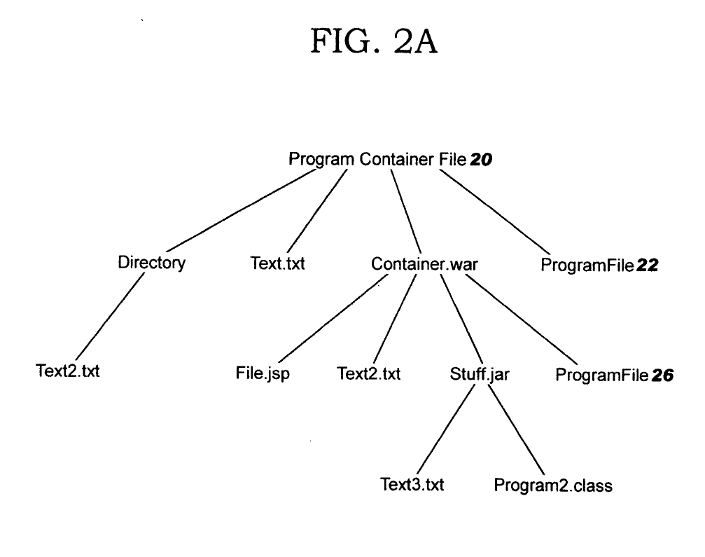

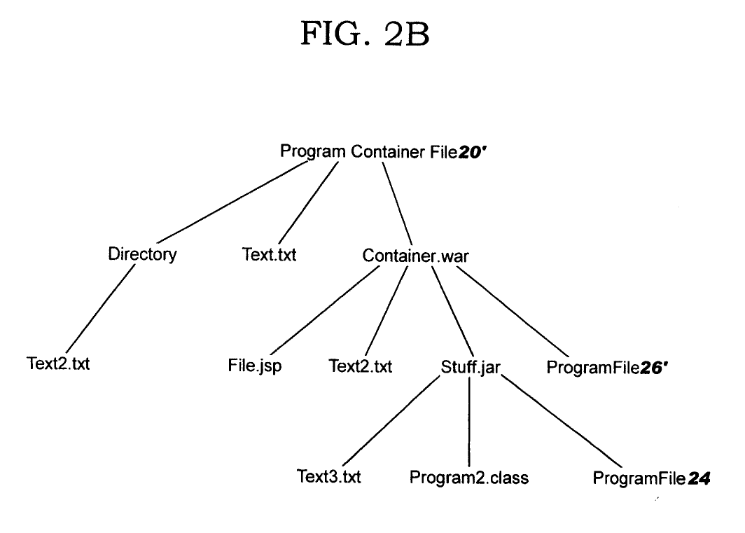

FIG. 2(a) illustrates the various hierarchical levels of a preexisting set of program container files 20 (although set 20 will typically be stored in compressed form). FIG. 2(b) illustrates the various hierarchical levels of an updated version 20′ of the preexisting set of program container files 20 (although set 20′ will typically be stored in compressed form). In the illustrated example, the first level of the overall hierarchy of the preexisting set of program container files 20 is simply a name of the set of program container files 20, i.e. Program Container File 20. The first level of the overall hierarchy of the updated set of program container files 20′ is simply a name of the set of program container files 20′, i.e. Program Container File 20′. The “second” level of the overall hierarchy of the set of program container files 20 comprises a Directory file, Text.txt file, Container.war program container file and ProgramFile22. The Container.war program container file of set 20 contains, in a third level of the overall hierarchy 20, a File.jsp file, Text2.txt file, a Stuff.jar program container file and a ProgramFile26. The Stuff.jar program container file of set 20 contains, in a fourth level of the overall hierarchy 20, a Text3.txt file and a Program2.class file. The “second” level of the overall hierarchy of the set of program container files 20′ comprises Directory file, Text.txt file, and Container.war program container file. The Container.war program container file of set 20′ contains, in a third level of the overall hierarchy 20′, File.jsp file, Text2.txt file, Stuff.jar program container file and a programFile26′. The Stuff.jar program container file of set 20′ contains, in a fourth level of the overall hierarchy 20′, Text3.txt file, Program2.class file and a ProgramFile24. Thus, the updated set of program container files 20′ is the same as the preexisting set of program container files 20 except for the following. The set of program container files 20′ does not include preexisting ProgramFile22 within set of program container files 20, i.e. ProgramFile22 has been deleted from set 20′. Set of program container files 20′ includes a new ProgramFile24 not found in the set of program container files 20, i.e. ProgramFile24 has been added to set 20′. The set of program container files 20′ includes ProgramFile26′ found in the set of program container files 20 as ProgramFile26 with the same name. However, in the set of program container files 20′, ProgramFile26′ includes some lines of code which are different than in ProgramFile26, i.e. the contents of ProgramFile26 has been changed in the set of program container files 20′.

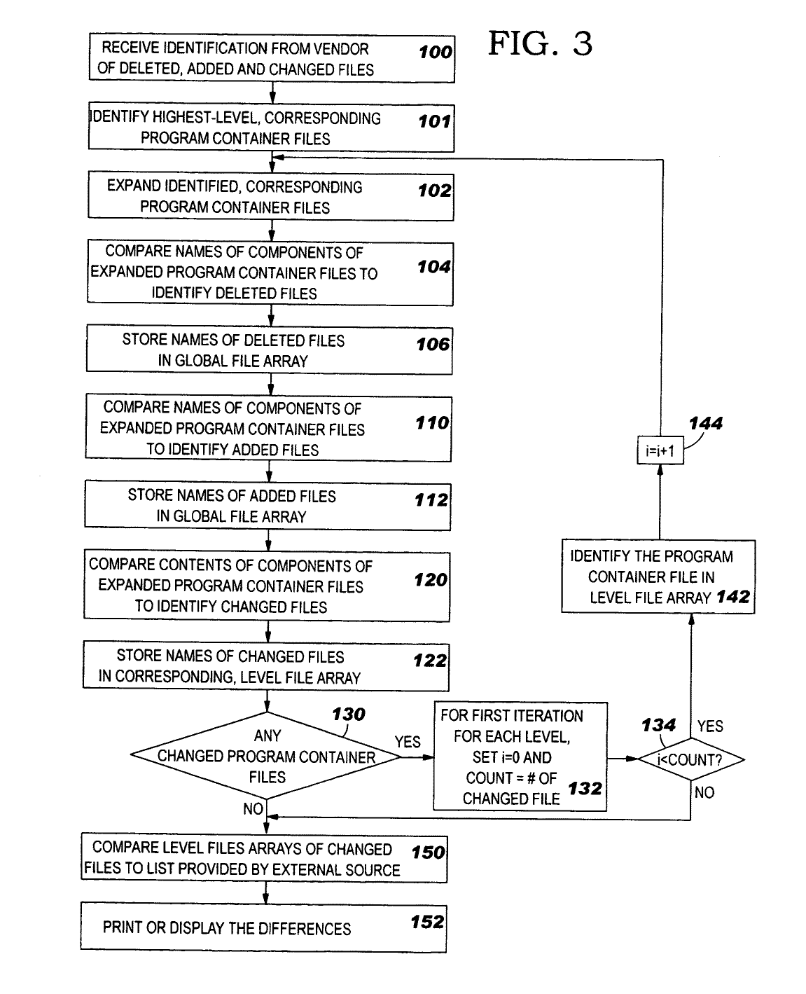

FIG. 3 is a flow chart illustrating the operation and function of program 50 in more detail. In the illustrated example, the preexisting set of program container files 20 has been updated into the updated set of program container files 20′. In step 100, the operator enters into computer 10 a list of the differences between the set of program container files 20 and the set of program container files 20 as specified by the vendor of these sets of program container files. The list specifies each file which has been deleted, added or changed when forming the updated set of program container files 20′. As explained below, this list will be compared to the deleted, added and changed files identified independently by program 50. In step 101, program 50 identifies the highest level of each set of program container files 20 and 20′. In step 102, program 50 expands the first (highest) level of the sets of program container files 20 and 20′ to yield the second (next highest) level of each set of program container files illustrated in FIGS. 2(a) and 2(b). In the illustrated embodiment, program 50 expands Program Container File 20 and Program Container File 20′ by issuing a known Sun Microsystems JAVA “JAR” command. The JAR function decompresses the Program Container File 20 and Program Container File 20′. Then, the JAR function checks the manifest of each of the Program Container File 20 and Program Container File 20′ to determine the contents of the respective, next hierarchical level. Then, the JAR function opens each of the program container files and other files in this respective, next hierarchical level. The “second” level of the overall hierarchy of the set of program container files 20, resulting from “expansion” of the Program Container File 20, comprises Directory directory, Text.txt file, Container.war program container file and ProgramFile22. The “second” level of the overall hierarchy of the set of program container files 20′, resulting from “expansion” of the Program Container File 20′, comprises Directory file, Text.txt file, and Container.war program container file.

Next, program 50 compares the names of the program container files and other files in the second level of the sets of program container files 20 and 20′ to identify any names of program container files or other files in the second level of the preexisting set of program container files 20 that do not appear in the second level of the updated set of program container files 20′ (step 104). This comparison is made for all the files in the second level, not just those identified by the operator in step 100. If any are found, they represent deleted program container files or other files, and program 50 records the names of the deleted program container files or other files in a global file array (step 106). Next, program 50 compares the names of the program container files or other files in the second level of the updated set of program container files 20′ to those in the second level of the preexisting set of program container files 20 to identify names of any program container files or other files that do not appear in the preexisting set of program container files 20 (step 110). This comparison is made for all the files in the second level, not just those identified by the operator in step 100. If any are found, they represent added program container files or other files, and program 50 records the names of the added program container files or other files in the global file array (step 112).

Next, program 50 compares the contents of each of the program container files or other files in the second level of the preexisting set of program container files 20 to the corresponding program container files or other files in the second level of the updated set of program container files 20′ to identify any program container files or other files for which the content has changed (step 120). This comparison is made for all the files in the second level, not just those identified by the operator in step 100. In the illustrated embodiment, in step 120, program 50 checks if any changes have been made to the corresponding program container files or other files, but not the substance of the changes. For example, in step 120, program 50 commands the operating system to check a “sum” value associated with each preexisting program container file or other file in the second level of the preexisting set and its corresponding, updated program container file or other file in the second level of the updated set. If the “sum” values differ, then some change has probably occurred. The “sum” operating system function is a known Unix, IBM AIX or Sun Solaris JAVA function which performs a function on the contents of each program container file or other file and returns a value (probably) unique to the contents. When the “sum” function is performed on a program container file or other file, the sum function treats the program container file or other file as an enormous binary number and divides it by another fixed binary number. The remainder from this division is the “sum”. (The checksum may comprise a thirty two bit cyclic redundancy check and byte count for the file.) To compare two corresponding program container files from the preexisting set and updated set, program 50 invokes the same “sum” function on all the files and program container identifiers within the program container file of the preexisting set and on all the files and program container identifiers within the corresponding program container file in the updated set, and then compares the two “sum” values. For example, if the sum function is performed on the Container.war program container file of FIG. 2(a), the sum function is performed on the Container.war identifier, File.jsp file, Text2.txt file, Stuff.jar identifier, Programfile 26, Text3.txt file and Program2.class file; however, the contents of the Container.war program container file is in a combined, compressed form, and the sum function is performed on the combined, compressed form. If the sum function is performed on the Container.war program container file of FIG. 2(b), the sum function will be performed on the Container.war identifier, File.jsp, Text2.txt, Stuff.jar identifier, Programfile26′, Text3.txt, Program2.class and ProgramFile24 files; however, the contents of the Container.war program container file is in a combined, compressed form, and the sum function is performed on the combined, compressed form. If the “sum” value for corresponding program container files or other files in the second level of the preexisting set of program container files and updated set of program container files differ, then there is a change (large or small) between the program container files or other files. (In an alternate embodiment of the present invention, in step 120, program 50 can conduct a line-by-line comparison of each pair of corresponding program container files and other files to identify the substance of the change, i.e. what lines of the file have changed and list the actual changes.) If any program container files or other files in the second level have changed in content, then program 50 records the names of the content-changed program container files and other files in a second level file array (step 122).

Next, program 50 reads the second level file array to determine if any of the program container files in the second level have changed in the updated set of program container files 20′ (decision 130). If so, then program 50 begins an iterative process for each such program container file in the second level that has changed to identify the program container files and other files within the changed program container file that have changed. Accordingly, for the first iteration within each level, program 50 sets an iteration variable “i” to zero and a “count” value equal to the number of changed program container files in the second level (step 132). If the value of the variable “i” is less than the count value (decision 134), then program 50 passes the preexisting form and updated form of the ith changed program container file to the expansion function of step 102. Thus, program 50 invokes the JAR function to expand the ith changed program container file from both the preexisting set and updated set, to identify any changes between the (lower level) program container files and other files within the ith changed program container file. The JAR function checks the program container file's manifest to determine the contents of the next hierarchical level. Then, the JAR function opens each of the program container files and other files in this next hierarchical level. Then, steps 104-122 are repeated for the ith preexisting program container file and the corresponding, changed program container file. In the foregoing example, where a changed program container file was detected in the second level, the expansion of the second level program container file will yield a third level group of program container file(s) and/or other file(s) for both the preexisting set and updated set.

For each changed program container file in the second level, there will be a respective third level group of program container file(s) and/or other file(s). After this iteration of steps 102-122, program 50 increments the iteration variable “i” (step 144), and repeats the foregoing steps 132, 134 and 142 for the next changed program container file in the second level file array. If any other program container files are identified as changed in step 120 for any iteration performed for a changed program container file in the second level file array, then they are added to a third level file array in step 122, and steps 132-144 and then 102-122 are repeated for these changed program container files in the third level after those steps are performed for all the changed program container files in the second level.

Referring again to decision 130, the no branch occurs after the last of the changed program container files has been processed through steps 102-122, all the deleted or added program container files or other files have been added to the global file array and all the changed program container files and other files have been added to the respective level arrays. Then program 50 compares the program container files and other files in the global file array and level file arrays to the list of deleted, added or changed files provided by the software vendor and entered into computer 10 in step 100 (step 150). If there are any differences, these are printed, displayed or otherwise reported to the operator for further evaluation (step 152).

Based on the foregoing, a system, method and program for identifying program container files and other files which have been deleted, added or changed, has been disclosed. However, numerous modifications and substitutions can be made without deviating from the scope of the present invention. For example, functions other than the “sum” function can be performed on corresponding program container files or other files to identify changes. Therefore, the present invention has been disclosed by way of illustration and not limitation, and reference should be made to the following claims to determine the scope of the present invention.

1. A computer program product for determining differences between a first preexisting program container file and a first updated program container file, the first preexisting program container file referencing a second preexisting program container file and a first preexisting program file, the second preexisting program container file referencing a second preexisting program file, the second updated program container file referencing a second updated program container file and a first updated program file, and the second updated program container file referencing a second updated program file, the program product comprising:
one or more computer-readable tangible storage devices and program instructions stored on at least one of the one or more storage devices, the program instructions comprising:
program instructions to determine (a) a first checksum encompassing the first preexisting program file in compressed form, the second preexisting program file in compressed form, an identifier in compressed form of the first preexisting program container file and an identifier in compressed form of the second preexisting program container file, and (b) a second checksum encompassing the first updated program file in compressed form, the second updated program file in compressed form, an identifier in compressed form of the first updated program container file and an identifier in compressed form of the second updated program container file;
program instructions, responsive to a difference between the first checksum and the second checksum, to
decompress the first preexisting program file and the first updated program file,
determine a third checksum of the first preexisting program file in uncompressed form and a fourth checksum of the first updated program file in uncompressed form, and responsive to a difference between the third checksum and the fourth checksum, record a difference between the first preexisting program file and the first updated program file,
determine (a) a fifth checksum encompassing the second preexisting program file in compressed form and the identifier in compressed form of the second preexisting program container file and (b) a sixth checksum encompassing the second updated program file in compressed form and the identifier in compressed form of the second updated program container file, and
responsive to a difference between the fifth checksum and the sixth checksum, decompress the second preexisting program file and the second updated program file and determine a seventh checksum of the second preexisting program file in uncompressed form and an eighth checksum of the second updated program file in uncompressed form, and responsive to a difference between the seventh checksum and the eighth checksum, record a difference between the second preexisting program file and the second updated program file.

2. The computer program product of claim 1 wherein the program instructions, responsive to a difference between the first checksum and the second checksum, also decompress a manifest of the first preexisting program container file to determine that the first preexisting program file is referenced by the first preexisting program container file, and decompress a manifest of the first updated program container file to determine that the first updated program file is referenced by the first updated program container file.

3. The computer program product of claim 2 wherein the program instructions, responsive to a difference between the fifth checksum and the sixth checksum, also decompress a manifest of the second preexisting program container file to determine that the second preexisting program file is referenced by the second preexisting program container file, and decompress a manifest of the second updated program container file to determine that the second updated program file is referenced by the second updated program container file.

4. The computer program product of claim 1 wherein the program instructions, responsive to a difference between the fifth checksum and the sixth checksum, also decompress a manifest of the second preexisting program container file to determine that the second preexisting program file is referenced by the second preexisting program container file, and decompress a manifest of the second updated program container file to determine that the second updated program file is referenced by the second updated program container file.

5. The computer program product of claim 1, further comprising:
program instructions, stored on at least one of the one or more storage devices, to compare to a list of program files which were expected to have changed, the record of the difference between the first preexisting program file and the first updated program file, and the record of the difference between the second preexisting program file and the second updated program file, and record a difference, if any, between the list and the records.

6. The computer program product of claim 1 wherein the first and second preexisting program container files and the first and second updated program container files are JAR files.

7. The computer program product of claim 1 wherein the first preexisting program file and the first updated program file are text files, and the second preexisting program file and the second updated program file are jsp files.

8. A computer system for determining differences between a first preexisting program container file and a first updated program container file, the first preexisting program container file referencing a second preexisting program container file and a first preexisting program file, the second preexisting program container file referencing a second preexisting program file, the second updated program container file referencing a second updated program container file and a first updated program file, and the second updated program container file referencing a second updated program file, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to determine (a) a first checksum encompassing the first preexisting program file in compressed form, the second preexisting program file in compressed form, an identifier in compressed form of the first preexisting program container file and an identifier in compressed form of the second preexisting program container file, and (b) a second checksum encompassing the first updated program file in compressed form, the second updated program file in compressed form, an identifier in compressed form of the first updated program container file and an identifier in compressed form of the second updated program container file;
program instructions, responsive to a difference between the first checksum and the second checksum, to
decompress the first preexisting program file and the first updated program file,
determine a third checksum of the first preexisting program file in uncompressed form and a fourth checksum of the first updated program file in uncompressed form, and responsive to a difference between the third checksum and the fourth checksum, record a difference between the first preexisting program file and the first updated program file,
determine (a) a fifth checksum encompassing the second preexisting program file in compressed form and the identifier in compressed form of the second preexisting program container file and (b) a sixth checksum encompassing the second updated program file in compressed form and the identifier in compressed form of the second updated program container file, and
responsive to a difference between the fifth checksum and the sixth checksum, decompress the second preexisting program file and the second updated program file and determine a seventh checksum of the second preexisting program file in uncompressed form and an eighth checksum of the second updated program file in uncompressed form, and responsive to a difference between the seventh checksum and the eighth checksum, record a difference between the second preexisting program file and the second updated program file.

9. The computer system of claim 8 wherein the program instructions, responsive to a difference between the first checksum and the second checksum, also decompress a manifest of the first preexisting program container file to determine that the first preexisting program file is referenced by the first preexisting program container file, and decompress a manifest of the first updated program container file to determine that the first updated program file is referenced by the first updated program container file.

10. The computer system of claim 9 wherein the program instructions, responsive to a difference between the fifth checksum and the sixth checksum, also decompress a manifest of the second preexisting program container file to determine that the second preexisting program file is referenced by the second preexisting program container file, and decompress a manifest of the second updated program container file to determine that the second updated program file is referenced by the second updated program container file.

11. The computer system of claim 8 wherein the program instructions, responsive to a difference between the fifth checksum and the sixth checksum, also decompress a manifest of the second preexisting program container file to determine that the second preexisting program file is referenced by the second preexisting program container file, and decompress a manifest of the second updated program container file to determine that the second updated program file is referenced by the second updated program container file.

12. The computer system of claim 8, further comprising:
program instructions, stored on at least one of the one or more storage devices for execution by at least one of the one or more processors via at least one of the one or more memories, to compare to a list of program files which were expected to have changed, the record of the difference between the first preexisting program file and the first updated program file, and the record of the difference between the second preexisting program file and the second updated program file, and record a difference, if any, between the list and the records.

13. The computer system of claim 8 wherein the first and second preexisting program container files and the first and second updated program container files are JAR files.

14. The computer system of claim 8 wherein the first preexisting program file and the first updated program file are text files, and the second preexisting program file and the second updated program file are jsp files.
